(19) United States
(12) Patent Application Publication
(10) Pub. No.: US 2016/0209988 A1
(43) Pub. Date: Jul. 21, 2016

(54) Information Input Device, Control Method and Storage Medium

(71) Applicant: NEC CORPORATION, Tokyo (JP)

(72) Inventor: Teruya IKEGAMI, Tokyo (JP)

(73) Assignee: NEC Corporation, Tokyo (JP)

(21) Appl. No.: 14/915,143

(22) PCT Filed: Mar. 6, 2014
(86) PCT No.: PCT/JP2014/055845

§ 371 Date: Feb. 26, 2016

(30) Foreign Application Priority Data
Sep. 6, 2013 (JP) 2013-184824

(51) Int. Cl. G06F 3/0481; G06F 3/0484

(52) U.S. Cl. CPC G06F 3/0481; G06F 3/04845; G06F 3/04842

(57) ABSTRACT

An information input device (2000) includes: a display execution unit (2020); an input state detection unit (2040); an operation detection unit (2050); and a display order modification unit (2060). The display execution unit (2020) displays a plurality of input areas on a display screen (10) according to a display order. The input state detection unit (2040) detects a state of input with respect to the input areas. The operation detection unit (2050) detects a predetermined operation with respect to the input areas. The display order modification unit (2060) modifies the display order of the input areas to a display order later than a current display order in a case in which the input for the input areas has not been completed when the predetermined operation for the input areas has been detected.

### TECHNICAL FIELD

The present invention relates to an information input device, a control method, and a program.

### BACKGROUND ART

There is an information input device that receives input of information with respect to a plurality of input areas. For example, the input area is a text box. A user selects an input area to which information is to be input and performs input with respect to the input area.

Research for reducing such an information input effort by a user has been conducted. For example, PTL 1 discloses a technology for reducing an effort required for an operation for displaying an input target area in a device in which only some input areas are displayed on a display screen. A diagnosis support device disclosed in Patent Literature 1 has a plurality of groups of input areas. Furthermore, when an input cursor positioned in an input area of a certain group has moved to an input area positioned at a front of a next group, the diagnosis support device changes screen display such that an input area of a movement destination is displayed at a front of the display screen.

### CITATION LIST

### Patent Literature

PTL 1: Japanese Unexamined Patent Application Publication No. 2003-288414

### SUMMARY OF INVENTION

### Technical Problem

A plurality of input areas displayed by an information input device are not limited to input areas arranged in an order in which a user desires to input information. When input areas are displayed in an order different from the order in which the user desires to input information, the user inputs information to each input area in an order different from the display order. That is, before input for some input areas is completed, input is firstly performed for input areas displayed after the input areas.

In the case in which input is subsequently performed for input areas for which input has not been completed, a user needs to remember input areas for which the input has not been completed or to perform an operation to search for the input areas for which the input has not been completed. Such work requires user's efforts.

In the case of Patent Literature 1, it is assumed that a user performs input with respect to input areas according to a display order. Therefore, Patent Literature 1 does not disclose a method for reducing user's efforts when input is performed for input areas in an order different from the display order.

Therefore, an object of the present invention is to provide a technology for reducing user's efforts when input is performed for input areas in an order different from a display order in an information input device.

### Solution to Problem

An information input device provided by the present invention includes: a display execution means which displays a plurality of input areas on a display screen according to a display order; an input state detection means which detects a state of input for the input areas; an operation detection means which detects a predetermined operation for the input areas; and a display order modification means which modifies the display order of the input areas to a display order later than a current display order in a case in which the input for the input areas has not been completed when the predetermined operation for the input areas has been detected.

A control method provided by the present invention includes: display execution step of displaying a plurality of input areas on a display screen according to a display order; an input state detection step of detecting a state of input for the input areas; an operation detection step of detecting a predetermined operation for the input areas; and a display order modification step of modifying the display order of the input areas to a display order later than a current display order in a case in which the input for the input areas has not been completed when the predetermined operation for the input areas has been detected.

A program provided by the present invention causes a computer to have functions serving as an information input device provided by the present invention. The program causes the computer to have functions of each function configuration unit included in the information input device provided by the present invention.

### Advantageous Effects of Invention

According to the present invention, in an information input device, a technology is provide to reduce user's efforts when input is performed for input areas in an order different from a display order.

### BRIEF DESCRIPTION OF DRAWINGS

The above-described objects, other objects, features, and advantages will be further apparent from the preferred exemplary embodiments described above and the accompanying drawings as follows.

FIG. 1 is a block diagram illustrating an information input device according to an exemplary embodiment 1.

FIG. 2 is a block diagram illustrating a hardware configuration of an information input device according to an exemplary embodiment 1.

FIG. 3 is a flowchart illustrating the flow of processing performed by an information input device of an exemplary embodiment 1.

FIG. 4 is a diagram illustrating input areas displayed on a display screen by an information input device of an example 1.

FIG. 5 is a block diagram illustrating an information input device according to an exemplary embodiment 2.

FIG. 6 is a diagram illustrating information, which is stored in a display order storage unit, in a table format.

FIG. 7 is a flowchart illustrating the flow of processing performed by an information input device of an exemplary embodiment 2.

FIG. 8 is a block diagram illustrating an information input device according to an exemplary embodiment 3.

FIG. 9 is a flowchart illustrating the flow of processing performed by an information input device of an exemplary embodiment 3.

FIG. 10 is a block diagram illustrating an information input device according to an exemplary embodiment 4.

FIG. 11 is a diagram illustrating input areas displayed on a display screen by an information input device of an example 2.

### DESCRIPTION OF EMBODIMENTS

Hereinafter, exemplary embodiments of the present invention will be described using the accompanying drawings. It is noted that similar reference numerals are used to designate similar elements in all the drawings and a description thereof will be appropriately omitted.

### Exemplary Embodiment 1

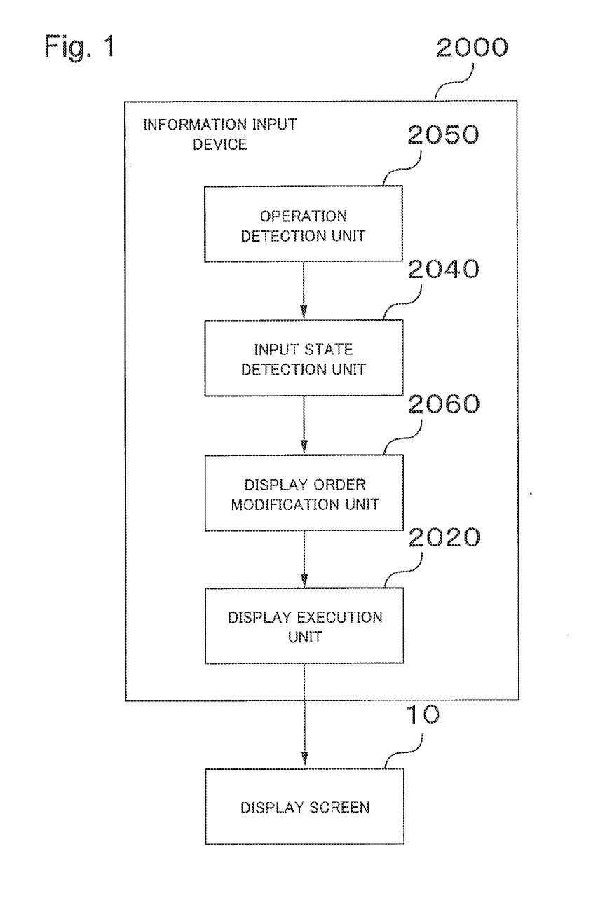

FIG. 1 is a block diagram illustrating an information input device 2000 according to an exemplary embodiment 1. In FIG. 1, an arrow indicates the flow of information. Moreover, in FIG. 1, each block does not indicate a hardware-based configuration and indicates a function-based configuration.

The information input device 2000 displays input areas on a display screen 10. The input areas are areas where an input operation by a user is received. For example, the input areas are text boxes, check boxes, radio boxes and the like. Furthermore, the input areas may also be a panel, a window and the like, which include a plurality of text boxes.

The display screen 10 may also be provided inside the information input device 2000 or may also be provided outside the information input device 2000. FIG. 1 illustrates the case in which the display screen 10 has been provided outside the information input device 2000.

The information input device 2000 is various computing machines. For example, the information input device 2000 is a portable terminal such as a cellular phone and a tablet PC (Personal Computer). Furthermore, the information input device 2000 may also be a desktop PC, a server computing machine and the like.

The information input device 2000 has a display execution unit 2020, an input state detection unit 2040, an operation detection unit 2050, and a display order modification unit 2060. Hereinafter, these function configuration units will be described.

<Display Execution Unit 2020>

The display execution unit 2020 displays a plurality of areas on the display screen 10 according to a display order.

<Input State Detection Unit 2040>

The input state detection unit 2040 detects a state of input for the input areas.

<Operation Detection Unit 2050>

The operation detection unit 2050 detects a predetermined operation for the input areas. The predetermined operation for the input areas is an operation indicating will of a user of the information input device 2000, which indicating “ends the input for the input areas”. The “ends the input” includes both the case of ending the input because the input has been completed and the case of temporarily deferring the input for the input areas although the input has not been completed.

<Display Order Modification Unit 2060>

The display order modification unit 2060 modifies a display order of the input areas to a display order later than the current display order in the case in which the input for the input areas has not been completed when the predetermined operation for the input areas has been detected. For example, the display order modification unit 2060 modifies a display order of input areas subjected to the predetermined operation so as to be the latest order among all the input areas.

By the above configuration, according to the information input device 2000 of the present exemplary embodiment, a display order of input areas subjected to a predetermined operation at the time of non-completion of input is modified to a display order later than the current display order. Therefore, in view of a user of the information input device 2000, the input areas are displayed again at a time point after the current time in a process of inputting information to other input areas. Therefore, a user does not need to display again input areas, for which input has not been completed, by a his/her operation or to search for the input areas for which the input has not been completed, so that it is possible to naturally perform input with respect to the input areas for which the input has not been completed. As a consequence, when input is performed for input areas in an order different from a display order, user's efforts are reduced.

<Hardware Configuration>

Each function configuration unit provided in the information input device 2000, for example, is realized as at least one hardware element in an individual state or in a state of a plurality of combinations. In addition, for example, each function configuration unit is realized as at least one software element. In addition, for example, each function configuration unit is realized by a combination of hardware elements and software elements.

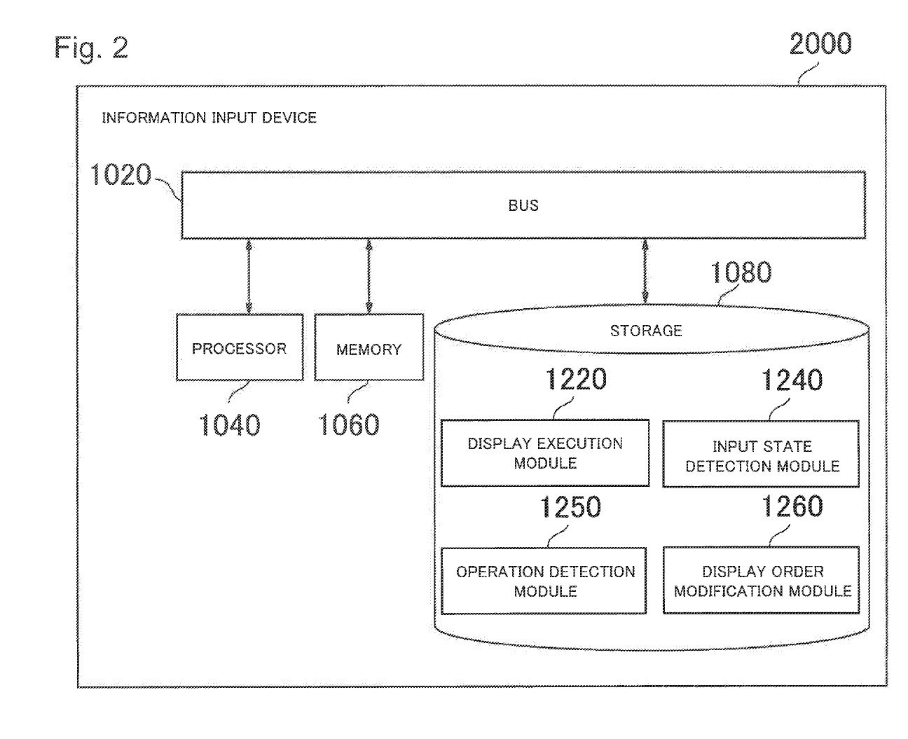

FIG. 2 is a block diagram illustrating a hardware configuration of the information input device 2000 according to the exemplary embodiment 1. In FIG. 2, the information input device 2000 has a bus 1020, a processor 1040, a memory 1060, and a storage 1080.

The bus 1020 is a data transmission path through which the processor 1040, the memory 1060, and the storage 1080 mutually transmit/receive data to/from one another. The processor 1040, for example, is an operation processing device such as a CPU (Central Processing Unit) and a GPU (Graphic Processing Unit). The memory 1060, for example, is a memory such as a RAM (Random Access Memory) and a ROM (Read Only Memory). The storage 1080, for example, is a storage device such as a hard disk, an SSD (Solid State Drive), and a memory card. Furthermore, the storage 1080 may also be a memory such as a RAM and a ROM.

A display execution module 1220 is a program causing the information input device 2000 to have functions of the display execution unit 2020. The processor 1040 executes the display execution module 1220, thereby performing the functions of the display execution unit 2020.

An input state detection module 1240 is a program causing the information input device 2000 to have functions of the input state detection unit 2040. The processor 1040 executes the input state detection module 1240, thereby performing the functions of the input state detection unit 2040.

An operation detection module 1250 is a program causing the information input device 2000 to have functions of the operation detection unit 2050. The processor 1040 executes the operation detection module 1250, thereby performing the functions of the operation detection unit 2050.

A display order modification module 1260 is a program causing the information input device 2000 to have functions of the display order modification unit 2060. The processor 1040 executes the display order modification module 1260, thereby performing the functions of the display order modification unit 2060.

For example, the processor 1040 reads and executes the aforementioned each module on the memory 1060. The processor 1040 may also execute the aforementioned each module without reading the aforementioned each module on the memory 1060.

The storage 1080 stores the aforementioned each module.

The hardware configuration of the information input device 2000 is not limited to the configuration illustrated in FIG. 2. For example, the aforementioned each module may also be stored in the memory 1060. In this case, the information input device 2000 may not also include the storage 1080.

<Flow of Processing>

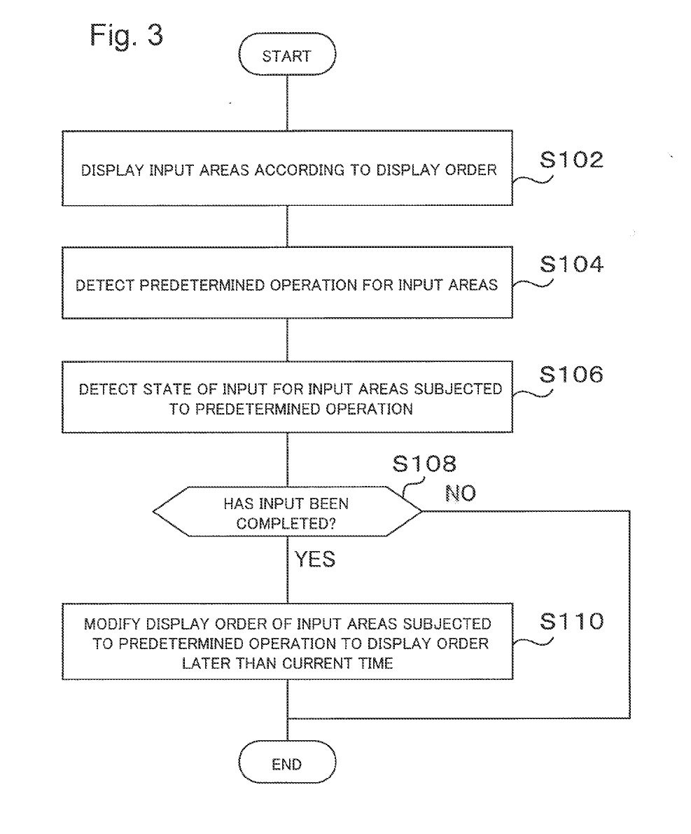

FIG. 3 is a flowchart illustrating the flow of processing performed by the information input device 2000 of the exemplary embodiment 1. In step S102, the display execution unit 2020 displays input areas according to a display order. In step S104, the operation detection unit 2050 detects a predetermined operation for the input areas. In step S106, the input state detection unit 2040 detects a state of input for the input areas subjected to the predetermined operation. In step S108, the display order modification unit 2060 determines completion or non-completion of the input for the input areas subjected to the predetermined operation. When the input for the input areas subjected to the predetermined operation has been completed (step S108: NO), the processing of FIG. 3 is ended. On the other hand, when the input for the input areas subjected to the predetermined operation has not been completed (step S108: YES), the processing of FIG. 3 proceeds to step S110. In step S110, the display order modification unit 2060 modifies a display order of the input areas subjected to the predetermined operation to a display order later than the current display order.

Hereinafter, the information input device 2000 of the present exemplary embodiment will be described in more detail.

<Details of Display Execution Unit 2020>

For example, in the case in which a predetermined operation for input areas has been detected, the display execution unit 2020 displays other input areas, which have a display order next to the display order of the input areas, in positions in which the input areas have been displayed. A user of the information input device 2000 performs an operation for ending input for the input areas, so that next input areas are automatically displayed in the positions in which the input areas have been displayed. For example, in the case in which input areas have been sequentially displayed downward in a vertical direction, when a predetermined operation is performed with respect to the input areas, the display execution unit 2020 allows next input areas to move up. In this way, a user does not need to perform an explicit operation (for example, a scroll operation) for displaying input areas which are next input targets, user's burden is reduced.

In addition, at this time, when there is an error in input for the input areas subjected to the predetermined operation, the display execution unit 2020 may not modify the display positions of the input areas. In this way, a user of the information input device 2000 is able to know that there is an error in the input for the input areas subjected to the predetermined operation. However, regardless of whether there is an error in the input for the input areas subjected to the predetermined operation, the display execution unit 2020 may also display other input areas, which have a display order next to the display order of the input areas, in the positions in which the input areas have been displayed.

Furthermore, when the predetermined operation for the input areas has been detected, in the case in which input for the input areas has been completed, the display execution unit 2020 may not display the input areas on the display screen 10. In this way, since only input areas, for which input has not been completed, are displayed on the display screen 10, the visibility of the input areas, for which the input has not been completed, increases. As a consequence, a user of the information input device 2000 is able to easily recognize the input areas for which the input has not been completed. Furthermore, when input for all input areas has been completed, all the input areas are not displayed. As a consequence, a user is able to easily recognize that all input works have been completed. Consequently, it is possible to prevent omission of input by a user.

<Details of Display Order Modification Unit 2060>

For example, when the predetermined operation for the input areas has been detected, the display order modification unit 2060 modifies the display order of the input areas such that the input areas are not displayed on the display screen 10. In this way, the visibility of other input areas displayed on the display screen 10 is improved.

In addition, for example, when the predetermined operation for the input areas has been detected, the display order modification unit 2060 modifies the display order of the input areas such that the display positions of the input areas on the display screen 10 are modified. In this case, it is preferable that the display order modification unit 2060 modifies the display order of the input areas such that the input areas are displayed in an inconspicuous region (for example, a corner of a screen) on the display screen 10. As described above, even when the display positions of the input areas subjected to the predetermined operation are modified to the inconspicuous region on the display screen 10, the visibility of other input areas is improved.

However, when there is an error in the input for the input areas subjected to the predetermined operation, the display order modification unit 2060 may not also modify the display order of the input areas. In this way, when the predetermined operation has been performed for the input areas, a user is able to know whether there is an error in the input for the input areas according to whether the input areas are continuously displayed in the same positions.

<Details of Input State>

A “state in which input for input areas has not been completed”, for example, is a state in which information has not been input to the input areas, a state in which input breaching a limitation has been made for input areas where there is a limitation in the number of input characters (the maximum number of input characters and the minimum number of input characters), and the like. Furthermore, the “state in which input for input areas has not been completed” may also include a state in which there is an error in the input for the input areas. The “state in which there is an error in the input for the input areas”, for example, is a state in which input breaching a limitation has been made for input areas where there is a limitation in a format (a half-sized character, a full-sized character, the Japanese language, the alphabet and the like) of characters which can be inputted. Furthermore, the “state in which there is an error in the input for the input areas” may also include the aforementioned state in which input breaching a limitation has been made for input areas where there is a limitation in the number of input characters.

<Details of Operation Detection Unit 2050>

Predetermined operations detected by the operation detection unit 2050 are various. For example, a predetermined operation for input areas is a contact operation or a click operation which is continuously performed for the input areas during a predetermined time or more. Herein, the contact operation for the input areas is an operation in which the input areas displayed on the display screen 10 is touched by an operating body. The operating body is a part (for example, fingers) of the human body, and an object such as a touch pen. Furthermore, for example, the predetermined operation for input areas is a contact operation or a click operation which is continuously performed for the input areas a plurality of times. For example, this operation is a double tap, a double click and the like. In addition, since a method for detecting the contact operation is a well-known technology, a description thereof will be omitted.

In addition, when the display of input areas are changed (display, deletion, a change of a display position, and the like), the information input device 2000 may also indicate a change of display by an animation. For example, when input areas are changed to separate positions on the display screen 10, the information input device 2000 performs an animation in which the input areas move from the original display positions to next splay positions. As described above, the animation is used, so that a user is able to intuitively recognize a change of display of input areas.

### Example 1

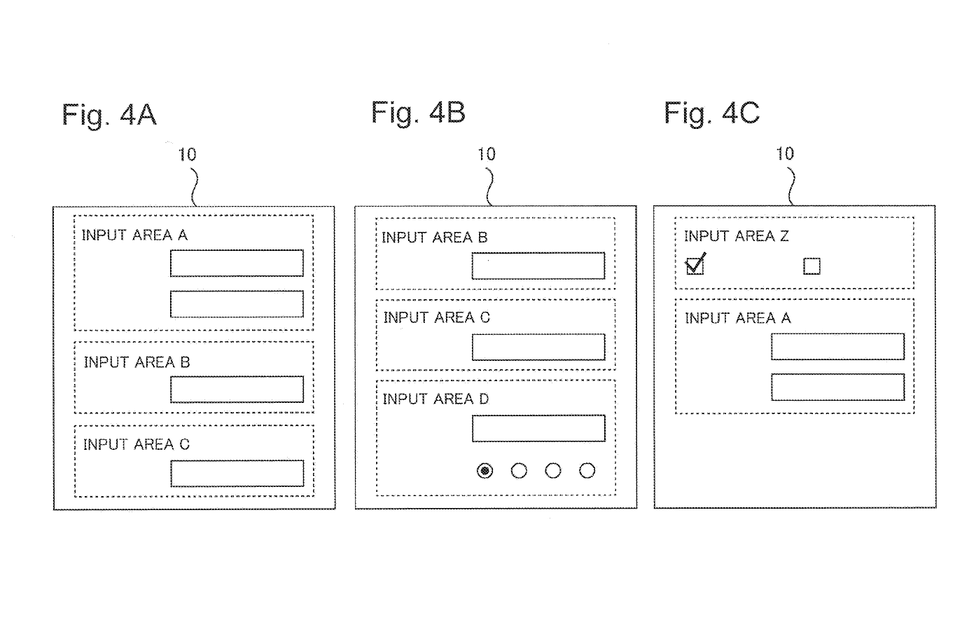

Through an example, an operation performed by the information input device 2000 of the present exemplary embodiment will be described. FIG. 4 is a diagram illustrating input areas displayed on the display screen 10 by the information input device 2000 of the example 1. In the present example, the information input device 2000 has input areas A to Z. In FIG. 4, the input area A includes two text boxes, input areas B and C each include one text box, an input area D includes one text box and one radio button including four choices, and an input area Z has two check boxes. In an initial state, a display order of the input areas A to Z is assumed to be an alphabetical ascending order. That is, the display order of the input area A is the first and the display order of the input area Z is the last. In the present example, when a predetermined operation has been performed for the input areas, in the case in which input for the input areas has not been completed, the display order modification unit 2060 sets the display order of the input areas as the latest display order.

FIG. 4(a) is a diagram illustrating display on the display screen 10 before a user performs an operation for the information input device 2000. In the case of FIG. 4 (a), the input areas A to C are displayed on the display screen 10.

In the state of FIG. 4(a), it is assumed that the user has performed a predetermined operation with respect to the input area A. At this time, it is assumed that input has not yet been performed for the input area A. In this case, since the input for the input area A has not been completed, the display order modification unit 2060 modifies a display order of the input area A to the latest display order. That is, the display order modification unit 2060 modifies the display order of the input area A to a display order next to a display order of the input area Z.

FIG. 4(b) is a diagram illustrating display on the display screen 10 after the display order of the input area A has been modified. As a result of the modification of the display order of the input area A by the display order modification unit 2060, other input areas are moved up from the below so as to fill a space where the input area A has not been displayed. As a consequence, the display on the display screen 10 is illustrated in FIG. 4(b).

FIG. 4(c) is a diagram illustrating display on the display screen 10 after input for the information input device 2000 is further continued from the state of FIG. 4(b). With respect to the input areas B to Y, a predetermined operation has already been performed after input is completed. As a consequence, in FIG. 4(c), only the input areas A and Z, for which input has not been completed, are displayed on the display screen 10. Furthermore, in the state of FIG. 4(a), since the display order of the input area A has been modified, the input area A is displayed after the input area Z.

As described above, a user is able to subsequently perform input for the input area A subjected to a predetermined operation in the state in which input has not been completed. Therefore, the user is able to naturally perform input for the input areas subjected to the predetermined operation in the state in which the input has not been completed without forgetting it. Furthermore, in the present example, input areas for which input has been completed are not displayed on the display screen 10, resulting in an increase in the visibility of input areas for which input has not been completed. Moreover, in the present example, when a predetermined operation has been performed for input areas, since next input areas are automatically moved up from the below, an operation to be performed by a user is reduced, so that user's burden is reduced.

<Operation•Effect>

By the above configuration, according to the information input device 2000 of the present exemplary embodiment, a display order of input areas, which have been subjected to a predetermined operation in the state in which input has not been completed, is modified to a display order later than the current display order. Therefore, a user of the information input device 2000 is able to perform input again with respect to the input areas, which have been subjected to the predetermined operation in the state in which the input has not been completed, at a time point after the current time in a process of inputting information to each input area. In view of the user, it is not necessary to display again input areas, for which input has been deferred, by a his/her operation or to search for the input areas for which input has been deferred, so that it is possible to naturally perform input again with respect to the input areas for which input has been deferred. As a consequence, user's efforts are reduced in the case in which input is performed for input areas in an order different from a display order.

As a use case of the information input device 2000 of the present exemplary embodiment, there is facility inspection in a building. For example, the information input device 2000 displays input areas as areas where inspection results of each facility are inputted. For example, inspection results regarding one facility relates to one input area.

Herein, there is a case in which it is not possible to catch in advance an inspection order in which an inspection worker inspects each facility. Therefore, an order of each facility, which is displayed by the information input device 2000, may be different from an order of facilities inspected by a worker.

In the case in which the information input device 2000 of the present exemplary embodiment is used, when input areas related to a facility to be inspected have been displayed, a user performs a predetermined operation after performing input with respect to the input areas. When input areas related to a facility separate from the facility to be inspected have been displayed, the user performs a predetermined operation in the state in which input for the input areas has not been completed. Furthermore, the input areas, which have been subjected to the predetermined operation in the state in which the input has not been completed, are displayed in a display order later than the current time. Therefore, a worker is able to naturally input inspection results regarding each facility without forgetting it while inspecting each facility in an order not related to a display order of input areas.

### Exemplary Embodiment 2

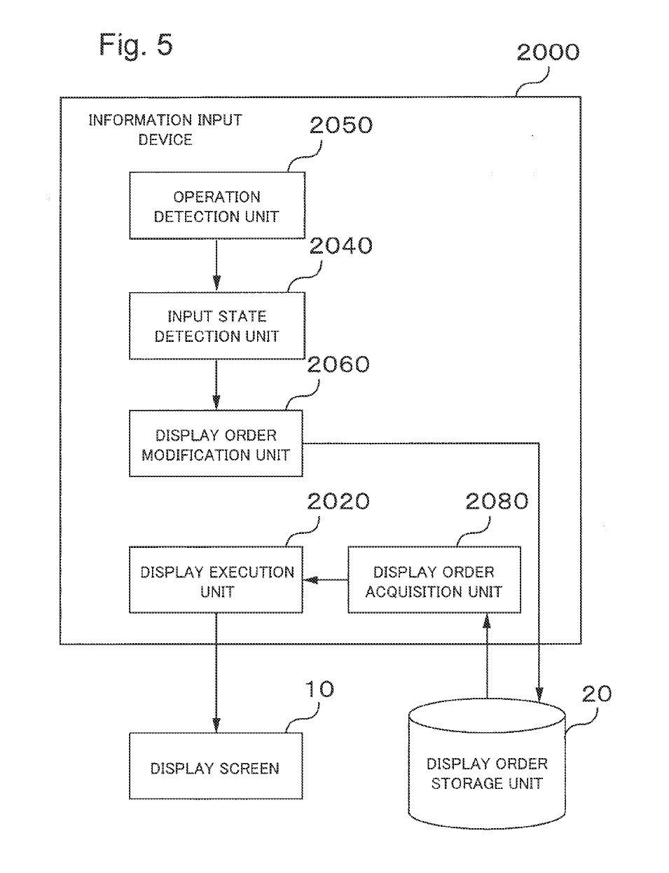

FIG. 5 is a block diagram illustrating the information input device 2000 according to an exemplary embodiment 2. In FIG. 5, an arrow indicates the flow of information. Moreover, in FIG. 5, each block does not indicate a hardware-based configuration and indicates a function-based configuration.

<Display Order Acquisition Unit 2080>

The information input device 2000 of the exemplary embodiment 2 has the display order acquisition unit 2080. The display order acquisition unit 2080 acquires a display order of each input area from a display order storage unit 20 that stores the display order of each input area. Herein, the display order storage unit 20 may be provided inside the information input device 2000 or may also be provided outside the information input device 2000. In the case of FIG. 5, the display order storage unit 20 has been provided outside the information input device 2000.

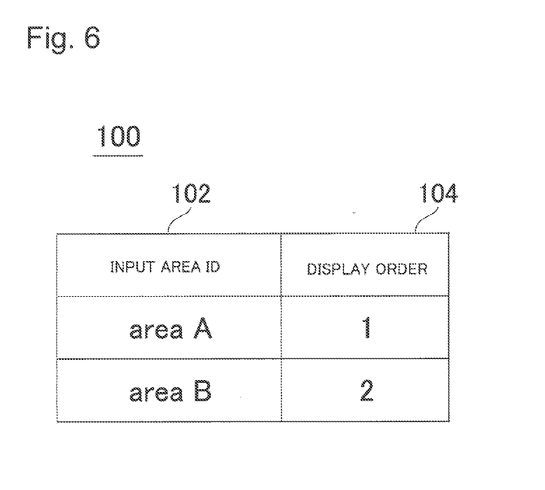

FIG. 6 is a diagram illustrating information, which is stored in the display order storage unit 20, in a table format. Hereinafter, the information illustrated in FIG. 6 is written as a display order information table 100. The display order information table 100 has two columns of an input area ID (102) and a display order 104. Each record of the display order information table 100 indicates a display order of an input area, which is specified by the input area ID (102), in the display order 104. For example, in FIG. 6, a record of the first row of the display order information table 100 indicates that a display order of an input area having an ID of area A is 1.

<Display Execution Unit 2020>

The display execution unit 2020 displays each input area according to the display order acquired by the display order acquisition unit 2080.

There are various methods in which the display execution unit 2020 displays input areas according to the display order acquired by the display order acquisition unit 2080. For example, the display execution unit 2020 displays the input areas in line in a vertical direction and a horizontal direction sequentially from an input area which is earlier in the display order. A method for displaying the input areas according to the display order may be set in advance with respect to the information input device 2000, or may also be manually or automatically input from an exterior. Furthermore, the information input device 2000 may also acquire the method from an exterior.

When it is not possible to display all input areas on the display screen 10 at a time, the display execution unit 2020, for example, receives an operation using a scroll bar and the like, thereby modifying input areas to be displayed on the display screen 10. Since a technology for modifying input areas to be displayed in response to a scroll operation and the like is well-known, a detailed description thereof will be omitted.

In addition, for example, the display execution unit 2020 may also divide a plurality of input areas into a plurality of pages for display. In this case, for example, the display execution unit 2020 displays an input area, which is earlier in a display order, in a page having a small page number.

<Display Order Modification Unit 2060>

When a predetermined operation for input areas has been detected, in the case in which input for the input areas has not been completed, the display order modification unit 2060 modifies the display order of the input areas stored in the display order storage unit 20. In detail, the display order modification unit 2060 modifies the display order of the input areas such that the display order is a display order later than the current display order. For example, it is assumed that the display order of the input areas is expressed by a numerical value so as to be indicated by the display order information table 100. In this case, the display order modification unit 2060 adds a numerical value of 1 or more to a display order of input areas subjected to a predetermined operation, thereby modifying the display order of the input areas to a display order later than the current display order.

<Flow of Processing>

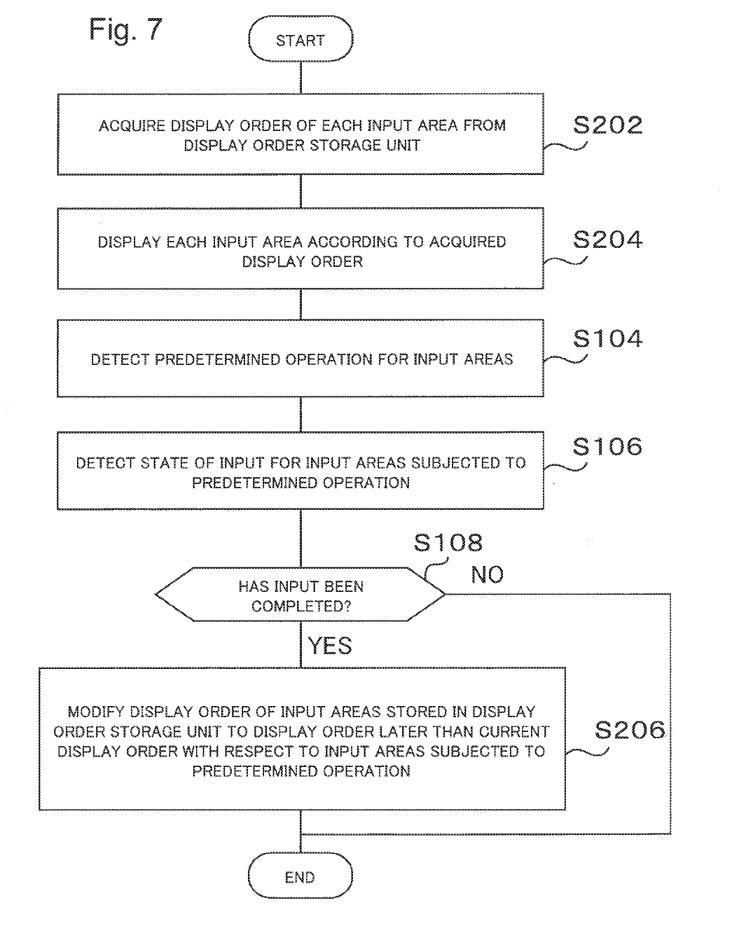

FIG. 7 is a flowchart illustrating the flow of processing performed by the information input device 2000 of the exemplary embodiment 2. Since steps S104, S106, and S108 of FIG. 7 are steps of performing processes similar to those of steps S104, S106, and S108 of FIG. 3, a description thereof will be omitted.

In step S202, the display order acquisition unit 2080 acquires a display order of each input area from the display order storage unit 20. In step S204, the display execution unit 2020 displays each input area according to the acquired display order.

When a processing result of step S108 is YES, step S206 is performed. In step S206, the display order modification unit 2060 modifies the display order of the input areas stored in the display order storage unit 20 to a display order later than the current display order with respect to input areas subjected to a predetermined operation.

<Operation•Effect>

In the present exemplary embodiment, a display order of each input area has been stored in the display order storage unit 20. Therefore, it is possible to display each input area in an order intended in advance. Furthermore, as illustrated in the display order information table 100, when the display order of the input areas is expressed by a numerical value, the display order modification unit 2060 performs a process of adding a numerical value of 1 or more to a display order of input areas subjected to a predetermined operation. In this way, it is possible to modify the display order of the input areas to a display order later than the current display order. Consequently, the display order modification unit 2060 is able to modify the display order of the input areas subjected to the predetermined operation by a simple process, so that a time required for a process by the display order modification unit 2060 is short.

### Exemplary Embodiment 3

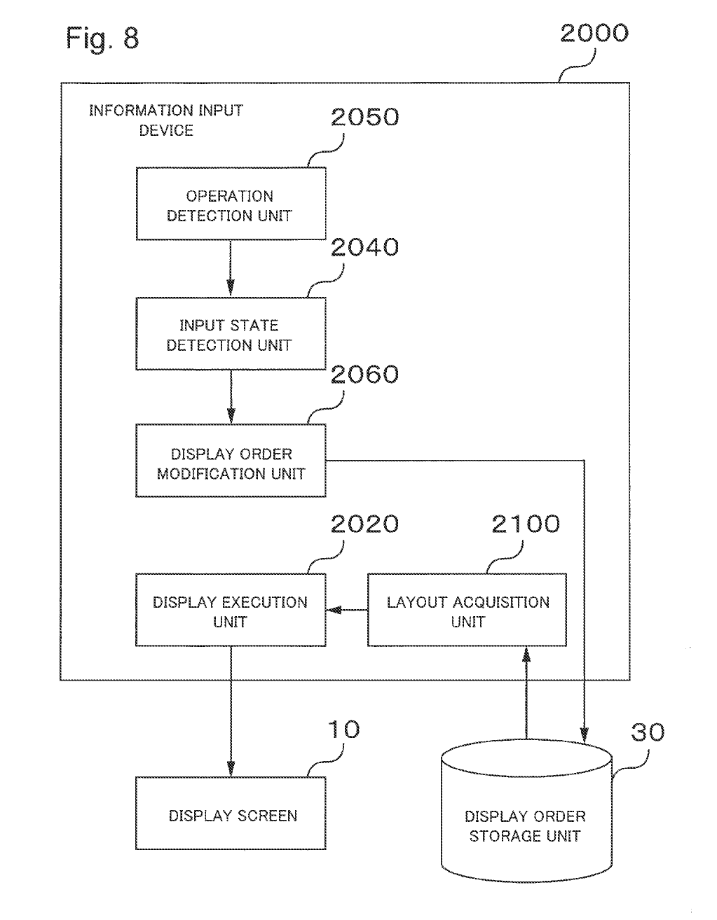

FIG. 8 is a block diagram illustrating the information input device 2000 according to an exemplary embodiment 3. In FIG. 8, an arrow indicates the flow of information. Moreover, in FIG. 8, each block does not indicate a hardware-based configuration and indicates a function-based configuration.

<Layout Acquisition Unit 2100>

The information input device 2000 of the exemplary embodiment 3 has the layout acquisition unit 2100. The layout acquisition unit 2100 acquires layout information from a layout storage unit 30. The layout information is information representing a relative positional relation of a plurality of input areas. Herein, the layout storage unit 30 may be provided inside the information input device 2000 or may also be provided outside the information input device 2000. In the case of FIG. 8, the layout storage unit 30 has been provided outside the information input device 2000.

For example, the layout information is information written with a HTML (Hyper Text Markup Language), an XML (Extensible Markup Language) and the like. However, the layout information is not limited to the information written with these languages.

<Display Execution Unit 2020>

The display execution unit 2020 of the exemplary embodiment 3 displays input areas in a display order based on a positional relation represented in the layout information.

For example, it is assumed that the layout information displays input areas in a vertical direction. In this case, for example, the display execution unit 2020 allows input areas positioned at an upper side in the layout information to be earlier in a display order. Furthermore, it is assumed that the layout information displays input areas in a horizontal direction. In this case, for example, the display execution unit 2020 allows input areas positioned at a left side in the layout information to be earlier in a display order. However, a correspondence between the position and the display order in the layout information is not limited to this method.

Furthermore, it is assumed that the layout information arranges input areas in both the horizontal direction and the vertical direction. In this case, for example, the display execution unit 2020 decides a display order of the input areas by using Equation 1 or Equation 2 below. P(i,j) is a display order of input areas positioned at an i^{th} row in the vertical direction and a j^{th} column in the horizontal direction. In Equation 1 below, n(k) is the total number of input areas displayed in the horizontal direction at a k^{th} row. Furthermore, in Equation 2 below, m(k) is the total number of input areas displayed in the vertical direction at a k^{th} column.

$$\begin{matrix}Equation 1 & \\ P ( i , j ) = {\sum }_{k < i - 1} n ( k ) + j & ( 1 ) \\ Equation 2 & \\ P ( i , j ) = {\sum }_{k < j - 1} m ( k ) + i & ( 2 )\end{matrix}$$

A method using Equation 1 above is suitable for the case in which an entire area (for example, an entire Web page) for displaying input areas and the like represented by the layout information is long in the vertical direction. On the other hand, a method using Equation 2 above is suitable for the case in which an entire area for displaying input areas and the like represented by the layout information is long in the horizontal direction. The layout information may also represent an Equation to be used between Equation 1 and Equation 2 above.

The display execution unit 2020 may also calculate, from the layout information, a direction, in which the entire area for displaying the input areas and the like is long, between the horizontal direction and the vertical direction. For example, the display execution unit 2020 compares the number and the size of input areas displayed in the horizontal direction with the number and the size of input areas displayed in the vertical direction, thereby calculating the direction, in which the input areas are long, between the horizontal direction and the vertical direction. In this case, the display execution unit 2020 may also decide an Equation to be used between Equation 1 and Equation 2 above in response to the direction, in which the entire area for displaying the input areas and the like is long, between the horizontal direction and the vertical direction.

<Display Order Modification Unit 2060>

The display order modification unit 2060 of the exemplary embodiment 3 modifies the position of input areas subjected to a predetermined operation in a positional relation represented by the layout information with respect to the input areas such that a display order of the input areas is a display order later than the current display order.

For example, it is assumed that the layout information displays input areas in the vertical direction. In this case, for example, the display execution unit 2020 modifies the position of input areas subjected to a predetermined operation to a position below the current position. Furthermore, for example, it is assumed that the layout information displays input areas in the horizontal direction. In this case, for example, the display execution unit 2020 modifies the position of input areas subjected to a predetermined operation to a right position from the current position.

<Flow of Processing>

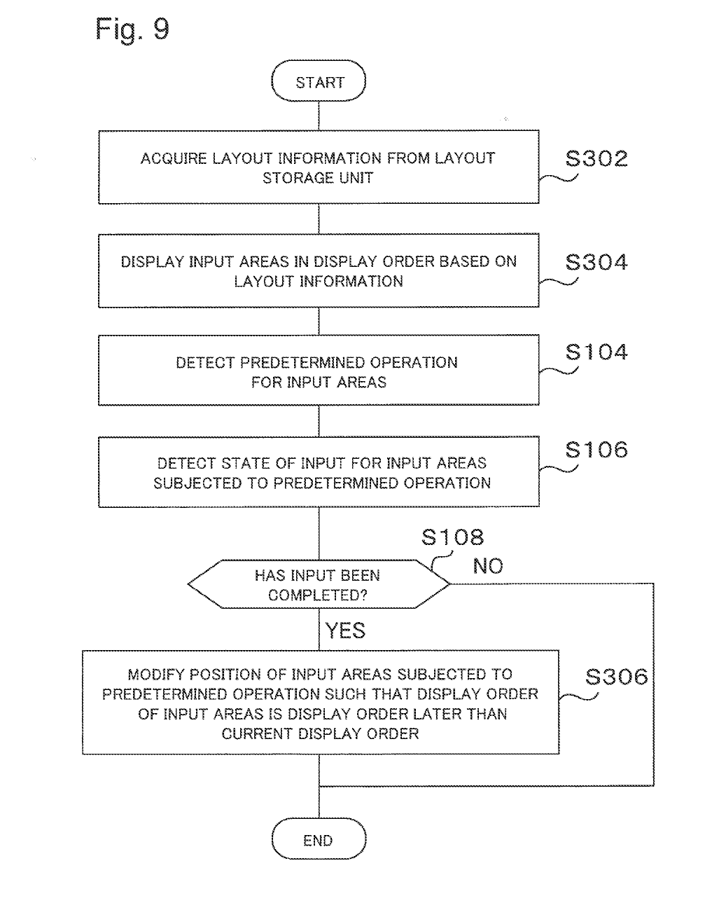

FIG. 9 is a flowchart illustrating the flow of processing performed by the information input device 2000 of the exemplary embodiment 3. Steps S104, S106, and S108 of FIG. 9 are steps of performing processes similar to those of steps S104, S106, and S108 of FIG. 3, a description thereof will be omitted.

In step S302, the layout acquisition unit 2100 acquires layout information from the layout storage unit 30. In step S304, the display execution unit 2020 displays input areas in a display order based on the layout information.

When a processing result of step S108 is YES, step S306 is performed. In step S306, the display order modification unit 2060 modifies the position of the input areas subjected to a predetermined operation such that the display order of the input areas is a display order later than the current display order.

<Operation•Effect>

According to the present exemplary embodiment, with respect to input areas, for which input has been deferred, the position of the input areas in a positional relation represented by layout information is modified such that the display order of the input areas is a display order later than the current display order. As described above, the position of the input areas, for which input has been deferred, on a layout is modified, so that it is possible to flexibly decide a method for displaying the position of the input areas for which input has been deferred.

### Exemplary Embodiment 4

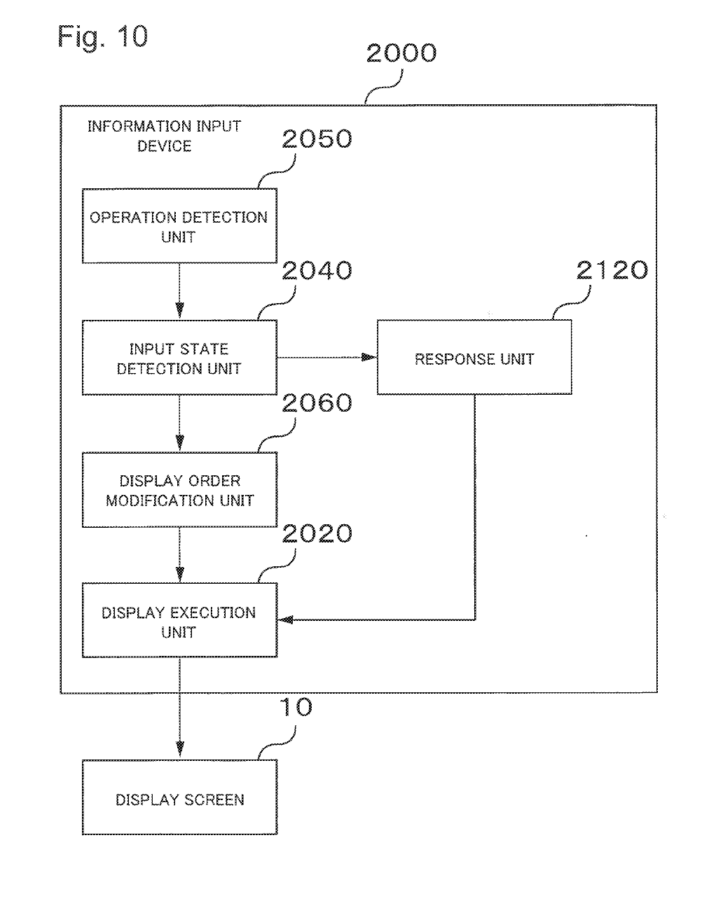

FIG. 10 is a block diagram illustrating the information input device 2000 according to an exemplary embodiment 4. In FIG. 10, an arrow indicates the flow of information. Moreover, in FIG. 10, each block does not indicate a hardware-based configuration and indicates a function-based configuration.

The information input device 2000 of the exemplary embodiment 4 has a response unit 2120. When a predetermined operation for input areas has been detected, the response unit 2120 modifies the color or the size of the input areas on the basis of the state of input for the input areas.

With respect to the input areas subjected to the predetermined operation, the response unit 2120 modifies the color of the input areas in response to one or more of whether input for the input areas has been completed and there is an error in the input for the input areas. For example, when the input for the input areas has been completed, the response unit 2120 modifies the color of the input areas to a color (for example, a blue, a green and the like) notifying a normal state. Furthermore, for example, when the input for the input areas has not been completed and there is no error in the input, the response unit 2120 modifies the color of the input areas to a color (for example, a yellow and the like) calling attention. Furthermore, for example, when the input for the input areas has not been completed and there is an error in the input, the response unit 2120 modifies the color of the input areas to a color (for example, a red and the like) notifying abnormality. In this way, a user of the information input device 2000 is able to intuitively know whether input for input areas has been completed and whether there is an error in the input for the input areas by a change in the color of the input areas.

In response to one or more of whether input for input areas subjected to a predetermined operation has been completed and whether there is an error in the input for the input areas, the response unit 2120 modifies the size of the input areas. For example, the response unit 2120 reduces the size in a sequence of 1) when input has not been completed and there is an error in the input, 2) when the input has not been completed and there is no error in the input, and 3) when the input has been completed. In addition, when the input has not been completed and there is an error in the input, the response unit 2120 may not also modify the size of the input areas. In this way, a user of the information input device 2000 is able to intuitively know whether there is an error in input for input areas subjected to a predetermined operation by a change in the size of the input areas. When the size of the input areas is reduced, the input areas can be seen to be pushed into the depth from the standpoint of a user. Moreover, when the input areas is pushed into the depth, input can be seen to be correctly received from the standpoint of a user. Accordingly, the response unit 2120 modifies the size of the input areas to the size following the aforementioned order.

### Example 2

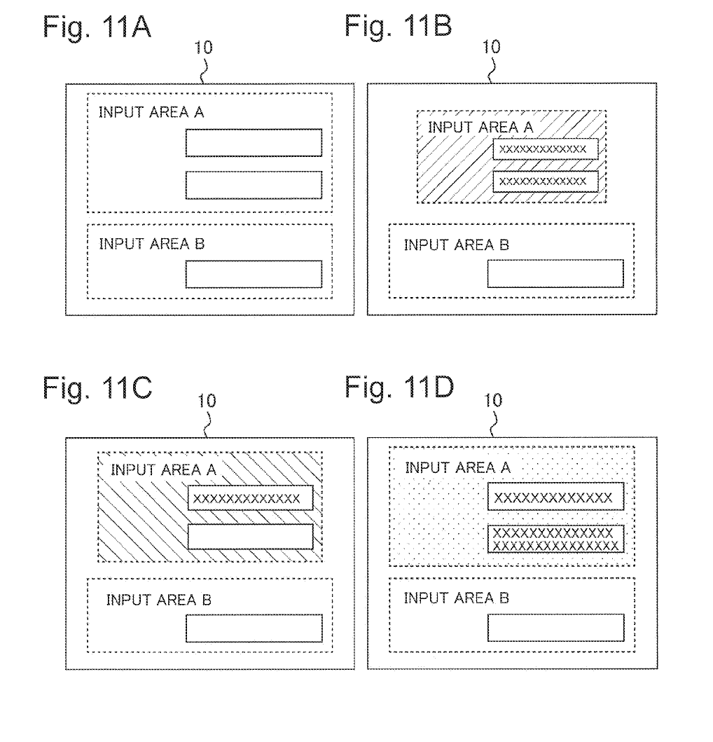

Through an example, an operation performed by the information input device 2000 of the present exemplary embodiment will be described. FIG. 11 is a diagram illustrating input areas displayed on the display screen 10 by the information input device 2000 of the example 2. FIG. 11(a) illustrates an initial state.

In the present example, when a user taps input areas once, the response unit 2120 modifies the color and the size of the input areas in response to the state of input for the input areas. Firstly, if no error is included in the input for the input areas, the response unit 2120 reduces the size of the input areas, thereby creating a shape such as being pushed into the depth. However, when the input for the input areas has been completed, the response unit 2120 reduces the size of the input areas as compared with the case in which the input for the input areas has not been completed. Furthermore, when an error is included in the input for the input areas, the response unit 2120 does not modify the size of the input areas.

Furthermore, when the input area has been tapped, the response unit 2120 modifies the color of the input areas as follows. When the input for the input areas has been completed, the response unit 2120 modifies the color of the input areas to a blue. When the input for the input areas has not been completed and no error is included in the input for the input areas, the response unit 2120 modifies the color of the input areas to a yellow. When the input for the input areas has not been completed and an error is included in the input for the input areas, the response unit 2120 modifies the color of the input areas to a red. In FIG. 11, the blue is indicated by oblique lines of a left obliquely downward direction, the yellow is indicated by oblique lines of a right obliquely downward direction, and the red is indicated by a dot pattern.

Furthermore, when the input areas, which have modified color and size by the tap of a user once, is tapped once more, the display execution unit 2020 and the display order modification unit 2060 perform processes related to the state of input for the input areas.

FIG. 4(b) illustrates display on the display screen 10 when an input area A has been tapped in the state in which input for the input area A has been completed. Since the input for the input area A has been completed, the response unit 2120 reduces the size of the input area A and modifies the input area A to a blue. In this way, a user is able to intuitively know that the input for the input area A has been completed. Furthermore, when the user taps the input area A once more, the display execution unit 2020 prevents the input area A from being displayed on the display screen 10 by deleting the input area A from the display screen 10.

FIG. 4(c) illustrates display on the display screen 10 when the input area A has been tapped in the state in which the input for the input area A has not been completed and no error is included in the input for the input area A. Since the input for the input area A has not been completed and no error is included in the input for the input area A, the response unit 2120 reduces the size of the input area A and modifies the input area A to a yellow. However, the size of the input area A in FIG. 4(c) is larger than the size of the input area A in FIG. 4 (b). As described above, the shape of the input area A is modified, so that a user is able to intuitively know that the input for the input area A has not been completed and no error is included in the input for the input area A. Furthermore, when the user taps the input area A once more, the display order modification unit 2060 modifies the display order of the input area A to a display order later than the current time.

FIG. 4(d) illustrates display on the display screen 10 when the input area A has been tapped in the state in which the input for the input area A has not been completed and an error is included in the input for the input area A. Since the input for the input area A has not been completed and an error is included in the input for the input area A, the response unit 2120 does not modify the size of the input area A and modifies the input area A to a red. In this way, a user is able to intuitively know that the input for the input area A has not been completed and an error is included in the input for the input area A. Furthermore, even when the user taps the input area A once more, the display order modification unit 2060 does not modify the display of the input area A.

As described above, the size and the color of the input area are modified in response to states for the input area, so that a user is able to intuitively know the states of input for the input area. Furthermore, when the user has performed an operation with respect to the input area again after confirming the states, the display execution unit 2020 and the display order modification unit 2060 perform processes, so that the intention of the user can be more reliably reflected in the display method of the input area.

For example, it is assumed that the input area has been modified to a yellow when the input area has been tapped. In this case, if a user has intentionally performed a tap operation in the state in which input has not been completed, the user performs the tap operation once more, thereby deferring input for the input area A. However, if the user has unintentionally performed the tap operation in the state in which the input has not been completed, the user knows the non-completion of the input in the step of the tap operation and is able to continuously perform input with respect to the input area A. As a consequence, user's thinking is not wastefully interrupted, so that it is possible to prevent work efficiency from being reduced.

So far, the exemplary embodiments of the present invention have been described with reference to the accompanying drawings, but these are examples of the present invention and it is also possible to employ combinations of the aforementioned exemplary embodiments and various configurations other than the aforementioned exemplary embodiments.

This application is based on Japanese Patent Application No. 2013-184824 filed on Sep. 6, 2013, the contents of which are incorporated herein by reference.

1. An information input device comprising circuitry configured to:
display a plurality of input areas on a display screen according to a display order;
detect a state of input for the input areas;
detect a predetermined operation for the input areas; and
modify the display order of the input areas to a later display order than a current display order in a case in which the input for the input areas has not been completed when the predetermined operation for the input areas is detected.

2. The information input device of claim 1, the circuitry further configured to:
acquire the display order of each of the input areas from a display order storage stored the display order with respect to each of the plurality of input areas,
wherein, in the modifying the display order, when the predetermined operation for the input areas is detected, in the case in which the input for the input areas has not been completed, modify the display order of the input areas stored in the display order storage to the later display order than the current display order.

3. The information input device of claim 1, the circuitry further configured to:
acquire layout information from a layout storage stored the layout information representing a relative positional relation of the plurality of input areas,
wherein
in the displaying the plurality of input areas, displaying the input areas in a display order based on the positional relation, and
in the modifying the display order, modifying a position of the input areas in the positional relation such that the display order of the input areas is the later display order than the current display order in the case in which the input for the input areas has not been completed when the predetermined operation for the input areas is detected.

4. The information input device of claim 1, wherein
when the predetermined operation for the input areas is has been detected, in the displaying the plurality of input areas, displaying other input areas, which have a next display order to the current display order of the input areas, in a position in which the input areas have been displayed.

5. The information input device of claim 1, wherein when the predetermined operation for the input areas is detected, in the case in which the input for the input areas has not been completed, in the modifying the display order, modifying the display order of the input areas such that the input areas are not displayed on the display screen.

6. The information input device of claim 1, wherein when the predetermined operation for the input areas is detected, in the case in which the input for the input areas has not been completed, in the modifying the display order, modifying the display order of the input areas such that a display position of the input areas on the display screen is modified.

7. The information input device of claim 1, the circuitry further configured to:
modify a color or a size of the input areas on a basis of the state of the input for the input areas when the predetermined operation for the input areas is detected.

8. The information input device of claim 1, wherein the predetermined operation for the input areas includes a contact operation or a click operation continuously performed for the input areas during a predetermined time or more, or a contact operation or a click operation continuously performed for the input areas a plurality of times.

9. A control method performed by a computer comprising processes of:
displaying a plurality of input areas on a display screen according to a display order;
detecting a state of input for the input areas;
detecting a predetermined operation for the input areas; and
modifying the display order of the input areas to a later display order than a current display order in a case in which the input for the input areas has not been completed when the predetermined operation for the input areas is detected.

10. The control method of claim 9, the processes further comprising:
acquiring the display order of each of the input areas from a display order storage means having stored the display order with respect to each of the plurality of input areas,
wherein, in the modifying the display order, when the predetermined operation for the input areas is detected, in the case in which the input for the input areas has not been completed, the display order of the input areas stored in the display order storage is modified to the later display order than the current display order.

11. The control method of claim 9, the processes further comprising:
acquiring layout information from a layout storage means stored the layout information representing a relative positional relation of the plurality of input areas,
wherein,
in the displaying the plurality of input areas, the input areas are displayed in a display order based on the positional relation, and
in the modifying the display order, a position of the input areas in the positional relation is modified such that the display order of the input areas is the later display order than the current display order in the case in which the input for the input areas has not been completed when the predetermined operation for the input areas is detected.

12. The control method of claim 9, wherein when the predetermined operation for the input areas is detected, other input areas, which have a next display order to the current display order of the input areas, are displayed in a position in which the input areas have been displayed in the displaying the plurality of input areas.

13. The control method of claim 9, wherein when the predetermined operation for the input areas is detected, in the case in which the input for the input areas has not been completed, the display order of the input areas is modified such that the input areas are not displayed on the display screen in the modifying the display order.

14. The control method of claim 9, wherein when the predetermined operation for the input areas is detected, in the case in which the input for the input areas has not been completed, the display order of the input areas is modified such that a display position of the input areas on the display screen is modified in the modifying the display order.

15. (canceled)

16. (canceled)

17. A non-transitory computer-readable storage medium storing a program, which causes a computer to execute processing for:
displaying a plurality of input areas on a display screen according to a display order;
detecting a state of input for the input areas;
detecting a predetermined operation for the input areas; and
modifying the display order of the input areas to a later display order than a current display order in a case in which the input for the input areas has not been completed when the predetermined operation for the input areas is detected.

18. The program of claim 17, the processes further comprising:
acquiring the display order of each of the input areas from a display order storage means stored the display order with respect to each of the plurality of input areas,
wherein when the predetermined operation for the input areas is detected, in the case in which the input for the input areas has not been completed, modify the display order of the input areas stored in the display order storage means to the later display order than the current display order in the modifying the display order.

19. The program of claim 17, the processes further comprising:
acquiring layout information from a layout storage stored the layout information representing a relative positional relation of the plurality of input areas,
wherein, in the displaying the plurality of input areas, displaying the input areas in a display order based on the positional relation, and
modifying a position of the input areas in the positional relation such that the display order of the input areas is the later display order than the current display order in the case in which the input for the input areas has not been completed when the predetermined operation for the input areas is detected.

20. The program of claim 17, wherein when the predetermined operation for the input areas is detected, displaying other input areas, which have a next display order to the current display order of the input areas, in a position in which the input areas have been displayed in the displaying the plurality of input areas.

21. The program of claim 17, wherein when the predetermined operation for the input areas detected, in the case in which the input for the input areas has not been completed, modifying the display order of the input areas such that the input areas are not displayed on the display screen in the modifying the display order.

22. The program of claim 17, wherein when the predetermined operation for the input areas is detected, in the case in which the input for the input areas has not been completed, modifying the display order of the input areas such that a display position of the input areas on the display screen is modified in the modifying the display order.

23. (canceled)

24. (canceled)
